(19) United States
(12) Patent Application Publication
(10) Pub. No.: US 2004/0048662 A1
(43) Pub. Date: Mar. 11, 2004

(54) Method and apparatus for improved gambling system including an additional ladder jackpot

(76) Inventor: David E. Ulmer, San Jose, CA (US)

Correspondence Address: Mr. David E. Ulmer, 6052 Burchell Avenue, San Jose, CA, 95120, US

(21) Appl. No.: 10/237,463

(22) Filed: Sep. 9, 2002

(51) Int. Cl. A63F 13/00

(52) U.S. Cl. 463/30

(57) ABSTRACT

A method and apparatus for an improved gaming system is provided. The system includes an additional jackpot, which requires advancing along a progression. A bonus configuration advances to the jackpot, while a bust configuration reduces the progression. For one embodiment, along the steps of the jackpot, there are intermediate payouts as well, which the user may select, rather than risking loss of the intermediate payout when a bust configuration is reached. For one embodiment, the bust configuration reduces the progression to its starting point.

### FIELD OF THE INVENTION

The present invention relates to gambling, and more specifically, to an additional moving jackpot.

### BACKGROUND

There are many gambling systems such as slot machines and video poker machines. Each of these machines has a payout based on the results obtained. For example, for video poker, there is a payout based on the card combination selected by the player. These types of systems are well known in the art.

In the prior art, an additional progressive jackpot was used to add excitement. A progressive jackpot was a single jackpot, which may have been shared among multiple systems, that was potentially available for a certain hand. Thus, for example, in addition to the “usual” payout for a Royal Flush in video poker, you could receive an additional payout. Alternatively, the system was set up to have a “jackpot” payout for the Royal Flush. Thus, the payout for a certain set of cards may have depended on the current number of gamblers, or other factors.

Gambling is a competitive field, and a system that adds excitement and encourages players to keep playing for an extended period is advantageous.

### SUMMARY OF THE INVENTION

A method and apparatus for an improved gaming system is provided. The system includes an additional jackpot, which requires advancing along a progression. A bonus configuration advances to the jackpot, while a bust configuration reduces the progression. For one embodiment, along the steps of the jackpot, there are intermediate payouts as well, which the user may select, rather than risking loss of the intermediate payout when a bust configuration is reached. For one embodiment, the bust configuration reduces the progression to its starting point.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of the system including the moving jackpot.

FIG. 2 is a diagram of one embodiment of the bonus/bust card appearance.

### DETAILED DESCRIPTION

A method and apparatus for an improved gambling system is described. The system is designed to add a new dimension of thrill and attraction to slot machine play, while increasing session times, machine volatility and revenues. The system provides an additional large jackpot to slot and video poker machines without significantly changing existing game play. This approach provides attraction to new and repeat players alike, as there are no complicated new rules to learn or confusing combinations to interpret.

The present system may be used on a video poker system, a slot machine, a reel based system, or any other system that could provide an additional jackpot. For simplicity, the present description will be with respect to video poker. However, one skilled in the art would understand that this may be extended to slots, blackjack, or any other machine or table based game.

The system includes a multi-rung tower, with a large jackpot at the top. The look would be similar to the old “swing the hammer to hit the bell” carnival games, with levels that light up along the tower on the way up to the jackpot. During regular game play, events occur which both advance and retreat the lights' progress up the tower. Along the way, players can opt to “Bank” the amount on the winning rung, or risk it all to advance to the next rung, with the ultimate goal being to advance the lights 10 steps to reach the million dollar prize.

The video poker version of the present system is played identically to Draw Poker, with a 52-card deck that reshuffles each hand. In this version of the game, however, two special events will be signaled which affect the ladder lights' movement up and down the jackpot tower. These two occurrences are the BONUS and the BUST.

The BONUS and BUST occurrences may be displayed in a number of different ways, including but not limited to:

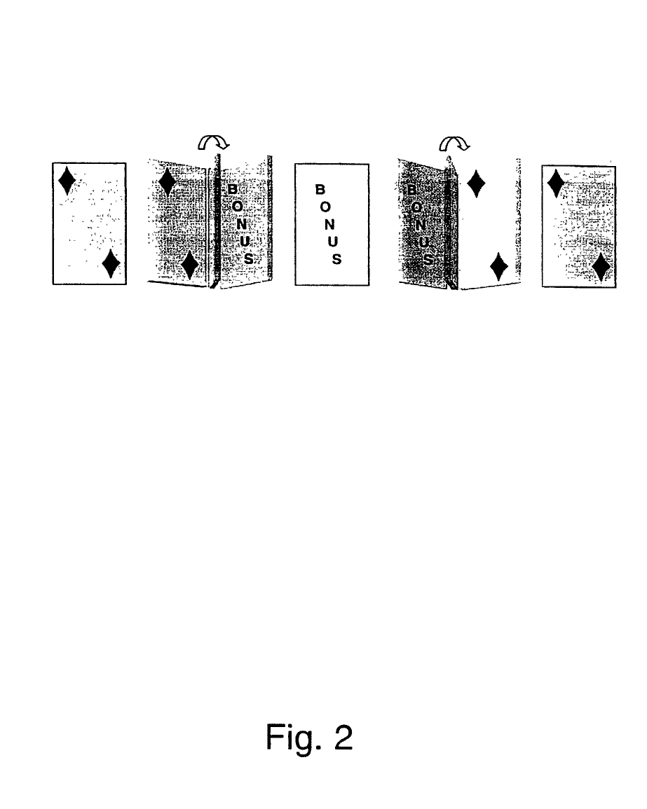

A multi-colored, labeled card back that is viewed on one of the dealt cards that spins within the player's hand for a variable number of seconds before settling into the actual playing card, as is shown in FIG. 2;

A flashing border or lights on the play field with a BONUS or BUST designation;

An appearance on a designated area on or above the machine itself, and/or on the jackpot tower 110.

These BONUS and BUST events affect the player's progress up and down the jackpot tower in the following manner.

The BONUS event causes the ladder lights to advance one rung upwards towards the jackpot. For one embodiment, the BONUS event is accompanied by visual and audible signals such as a flashing border on the achieved rung and a loud pleasant sound effect. For example, the event could be emphasized with three “bongs” in time with a three-fold flashing of the achieved ladder rung. The new ladder rung would then be temporarily frozen at that level, lit brightly to signify the level reached.

The BUST card serves the opposite function of the BONUS card. When BUST occurs, the ladder lights drop down. For one embodiment, the ladder lights drop all the ways back down to the ladder's beginning position. For one embodiment, the BUST event is accompanied by visual and audible cues, such as a buzzing sound and a momentary red border (or another color) on the current level and then red borders momentary red borders progressing downwards along each rung of the ladder to the bottom, with audible accompaniment. For another embodiment, the ladder lights may drop only part of the way down.

The present system introduces both a new level of volatility and risk to an otherwise standard video, slot machine, or table game. Each rung on the jackpot tower not only designates a progression up towards the ultimate jackpot, but also holds a reward of its own. However, that reward is only available as long as that rung is lit. If the BUST event occurs, before the player chooses to “Bank” the rung's payoff, the ladder resets to zero.

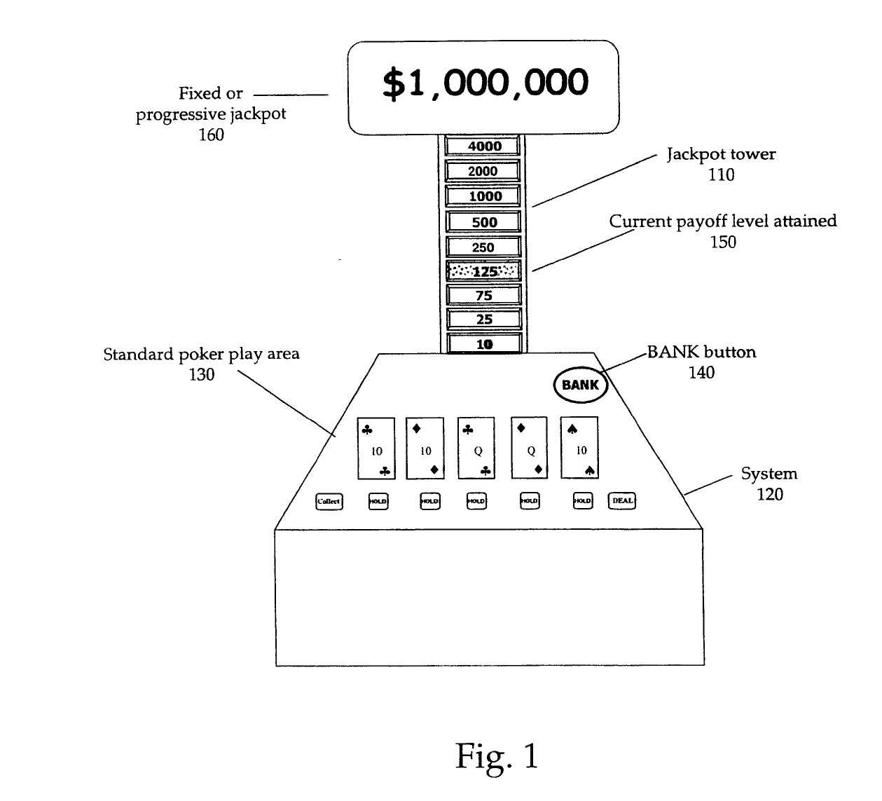

Each rung of the jackpot tower holds an additional payoff for the player, if they choose to take it before a BUST event occurs. FIG. 1 illustrates the jackpot tower 110, with the progressive amounts illustrated. Note that the amounts shown are merely exemplary. These amounts, however, are variable, in that they can be adjusted to the casino's desired payoff level. The rung payoff amounts are directly related to the probability ratio between the occurrences of BONUS and BUST events. The machine can be set to have a lower ratio between BONUS and BUST, with the probability of more BONUS's for every BUST. Conversely, a higher ratio, with the probability of fewer BONUS's for each BUST, would necessarily require lower rung payoff amounts. The present system is designed for complete adjustability from the precise amounts, to the occurrences of the Bonus and Bust events.

As can be seen in FIG. 1, the current payoff level attained 150 is highlighted, and there is a huge jackpot sign 160 at the top of the jackpot tower 110, showing the goal towards which the player is progressing.

The system may be a conventional playing system 120, having a standard playing area 130. For one embodiment, the only additional feature on the system 120 itself is the addition of a BANK button 140. At any time while a ladder rung is lit, a player may choose to receive that rung's payout amount rather than risk encountering a BUST event. The BANK button 140 can be in any visual configuration or color, but is for one embodiment large and tactilely energetic. For one embodiment, when a rung is flashing, the BANK button 140 also lights up and flashes simultaneously. For one embodiment, as long as a rung is lit, the BANK button 140 is brightly lit. For one embodiment, the BANK function is automatically activated when the Collect button is pressed. Thus, when the player cashes out, they would also receive current payoff level 150

The jackpot 160 is earned once the player successfully advances the ladder light rungs, by obtaining BONUS events without either hitting a BUST or BANKing a rung payoff. The jackpot 160 can be either a fixed amount, or a Progressive Jackpot tied to any number of machines on a single bank.

Another feature of the jackpot—which could be used on any other type of large jackpot payout machine as well—is to have a pneumatic air pump 170 activated when the jackpot is hit to blast confetti into the air as the lights flash and music or sound effects play. This would add excitement, as well as make it obvious to the management that someone won. It likely also makes an excellent photo opportunity.

In all other ways, the game plays as a standard video poker game, with the pay table modified slightly downwards to accommodate the ladder jackpot payout. One recommended pay table would be a standard Bonus Poker pay table but with even money paid on Two Pairs.

As with any other video poker machine, the house advantage within the scope of the regular poker hand payoffs would be determined by the payoff schedule vs. the random odds of attaining any particular poker hand, with the added objective of supporting the ladder jackpot and interim ladder payoffs. The Ladder jackpot payoff odds, however, are determined by a randomizer affecting the BUST frequency and its ratio to the BONUS frequency. By adjusting the ratio between BONUS and BUST events and the payoff schedule for the regular poker play, one could establish varying levels for the Ladder jackpot total. A higher BUST ratio would support multi-million dollar payouts, whereas a lower frequency would increase both the progression speed and heights that the ladder lights attain.

Although the example shown in FIG. 1 is that of a video poker machine, the jackpot tower may be used with any other machine. Furthermore, the jackpot tower 110 may be used for a table-based game. The tower 110 can be physically attached anywhere, on a separate stand, or attached to the table itself. The Bonus and Bust events may take place using a randomizer and lights at each player's spot, that lights up the events. Alternatively, the Bonus/Bust events may be triggered by special cards. For another embodiment, the Bonus/Bust events may be time-based and signaled on the tower itself 110. Thus, for example, the tower 110 may include electronics to periodically generate a random number corresponding to “no action,” “bonus,” or “bust”. In that instance, the ladder structure is completely separate from the game play. In general, the dealer does not track and is not responsible for any events, to eliminate any opportunity for cheating.

The present system games provide the obvious attraction of a very large jackpot, plus increased sensory excitement of the climbing lights with accompanying sound effects, all with one additional level of interactive risk. Even from a distance, guests would be able to see tower lights climbing the rungs towards the million dollar payoffs. The interim rung payouts would increase the game's volatility. The added attraction to experienced players is that there are no new rules or strategies to learn. The present system progression is merely an adjunct to their regular game play.

The added benefits to the house are two-fold. First, the present system brings a new level of excitement and innovation to gaming. It adds the thrill of ladder jackpot payoffs and increased volatility to games that heretofore could not support them, while increasing each machine's overall earnings. New and casual players, who might otherwise pass up a normal machine, would be tempted to take that one shot at a life-changing jackpot. Experienced and frequent players would be attracted to play a machine with a lower pay table for the chance of hitting the “big one.”

Secondly, the present system increases the player's time per session. The objective of any slot machine is to attract players and keep them there. The ladder jackpot will attract players. The ladder light progression will keep them from leaving. As the lights climb higher and higher towards the Ladder jackpot, players will become increasingly less likely to walk away.

As with any other slot system, the machines using the present system can be linked across both internal and multi-casino banks, to allow for a progressive jackpot. For example, a single progressive Ladder jackpot could traverse all machines in a single bank or across hotel properties. Thus, the jackpot 160 could be quite large.

The present system is designed to apply to any form of slot machine or table game, in addition to video poker. On a slot reel, the BONUS and BUST events may be implemented via the addition of such symbols on the reels themselves. Alternatively, a separate display area may provide the BONUS and BUST events.

For another embodiment, the BONUS and BUST occurrences can also be generated within the Players Club Card system, appearing within the player rewards windows, as a means to encourage Club participation or on additional lights and or buttons on the machines.

Alternatively, a simple time-based system may be incorporated into the jackpot tower itself. Note that although the jackpot tower 110 is illustrated here vertically, extending from the machine, it could be horizontal, or may be incorporated within the body of the machine itself. Thus, the actual format of the jackpot tower 110 is irrelevant.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus to enhance playing a game, the apparatus comprising:
a jackpot tower including a plurality of rungs; and
a bonus event capable of occurring while a user is playing the game, the bonus event moving the payoff level on the jackpot tower upward; and
a bust event capable of occurring while the user is playing the game, the bust event moving the payoff level on the jackpot tower downward.
